(19) United States
(12) Patent Application Publication
(10) Pub. No.: US 2008/0251196 A1
(43) Pub. Date: Oct. 16, 2008

(54) METHOD FOR PRODUCING A FASTENING ARRANGEMENT OF A FIXING DOME ON A THIN-WALLED COMPONENT

(75) Inventors: Michael STUMPF, Bielefeld (DE); Hartmut SCHNELLER, Bochum (DE)

Correspondence Address: SEYFARTH SHAW LLP, 131 S. DEARBORN ST., SUITE 2400, CHICAGO, IL, 60603-5803, US

(73) Assignee: Bollhoff Verbindungstechnik GmbH

(21) Appl. No.: 12/100,515

(22) Filed: Apr. 10, 2008

(30) Foreign Application Priority Data
Apr. 10, 2007 (DE) 10 2007 016 851.0

(51) Int. Cl. B32B 37/00

(52) U.S. Cl. 156/275.5; 156/60

(57) ABSTRACT

A method is described for producing a fastening arrangement of a column-shaped fixing dome of synthetic material on a thin-walled component of synthetic material, for example, a housing. The fixing dome and the thin-walled component are produced separately from each other. Here, a fastening element is integrated in the fixing dome, and an end of the fixing dome is formed as a joining section. In addition, on the inner side of the component, a joining section is built that is matched to the joining section of the fixing dome, in order to build a join connection with said join section for positioning the fixing dome on the component. The join section of the component and/or the join section of the fixing dome are now wetted with an non-curing adhesive. Subsequently, the component and the fixing dome are joined for producing the join connection and through light curing of the adhesive are fixedly connected together.

### BACKGROUND OF THE INVENTION

The present invention relates to a method for producing a fastening arrangement of a column-shaped fixing dome of synthetic material on a thin-walled component of synthetic material, and a fastening arrangement therefore.

In order to be able to fasten thin-walled components of synthetic material, such as housings for vacuum cleaners, lawn tillers, or the like, usually during injection molding of the thin-walled component, so-called fixing domes are molded onto the inner side of the component. Such fixing domes have a height, for example, of 30 to 150 mm. Metallic fixing parts in the shape of, for example, threaded nuts or threaded bolts are inserted in the fixing dome in a further processing step. During this production method, several problems arise:

In the case of an unfavorable ratio of the wall thicknesses of the thin-walled component and the fixing dome, on the visible side of the housing, opposite the inner side, so-called sink marks can result, which in most cases are unacceptable.

Because during injection molding process, the material for the fixing dome is initially injected into the hollow space for the housing, and from there must pressed forward into the hollow spaces for the fixing domes, the injection process requires a relatively large amount of time. The larger the dimensions of the fixing dome, the longer the duration of the injection cycle.

In order to be able to inject the fixing dome onto the housing, a relatively complex, involved, and therefore expensive injection molding tool is required.

### SUMMARY OF THE INVENTION

The present invention solves the objective to create a method for producing a fastening arrangement of a column-shaped fixing dome of synthetic material on a thin-walled component of synthetic material, and a fastening arrangement produced according to this method, which are characterized by high cost-effectiveness, and which minimize the danger of sink marks on the visible side of the thin-walled component opposite the fixing dome.

This objective is solved by the method defined in Claim 1.

According to the invention the fixing dome and the thin-walled component are produced separately from each other. Here, a fastening element is integrated in the fixing dome, and one end of the fixing dome is constructed as a joining section. In addition, a joining section is built on the inner side of the component that is matched to the joining section of the fixing dome, in order to be able to build a join connection with said joining section for positioning the fixing dome on the component.

The join section of the component and/or the join section of the fixing dome are then wetted with an adhesive, preferably a light-curing adhesive. Then, the component and the fixing dome are joined for producing the join connection, and through curing of the adhesive, especially through light radiation of a specific wavelength, are fixedly connected together.

Here, the join section of the thin-walled component can easily be formed such that the danger of sink marks on the visible side of the component is avoided. Because the component and the fixing domes are manufactured in separate processing steps, the manufacture of the component can correspondingly be simplified. If the component is produced through injection molding, the invention enables considerably shortened injection cycles, and significantly simplified injection molding tools.

When the fixing dome is produced from a translucent, especially a transparent synthetic material, preferably a fast-curing adhesive is used. After the join connection between the component and the fixing dome is produced, the curing of the adhesive is then initiated by means of a light radiation of a specific wavelength.

If for some reason, the fixing dome can not be produced from a translucent material, a slow-curing adhesive is used expediently. Then, the curing of the adhesive by means of a light radiation of a specific wavelength is already initiated before the join connection between the component and the fixing dome is produced. After producing the join connection, the adhesive can gradually cure completely.

The invention is especially suited for thin-walled components in the shape of housings, e.g., for vacuum cleaners, lawn tillers, however, it can also be used for any other thin-walled components, such as bumpers, whose fastening requires the use of fixing domes.

The fastening element can be composed of a different material than the fixing dome, and during the production of the fixing dome can be imbedded in it. Instead, the fastening element can be composed from the same material as that of the fixing dome, and can be produced with it as a single piece.

The fastening element is, for example, a threaded sleeve, a threaded bolt, a stay bolt, a wire thread insert, etc., however, it can also be any arbitrary fastening element from producing a locking connection, a coupling, a quick release fastener, or the like.

Further advantageous designs and further developments of the invention are defined in the dependent claims.

### BRIEF DESCRIPTION OF THE FIGURES

Exemplary embodiments of the invention are explained in more detail using the accompanying figures in which

FIG. 1 is a perspective sectional view of a fastening arrangement according to the invention.

FIG. 2 is a perspective sectional view, corresponding to FIG. 1, of a modified embodiment of the invention;

FIG. 3 is a sectional view, corresponding to FIGS. 1 and 2, of a further embodiment of the invention;

FIG. 4 is a modified embodiment of the fixing dome in FIG. 3.

### DETAILED DESCRIPTION OF THE EXEMPLARY EMBODIMENTS OF THE INVENTION

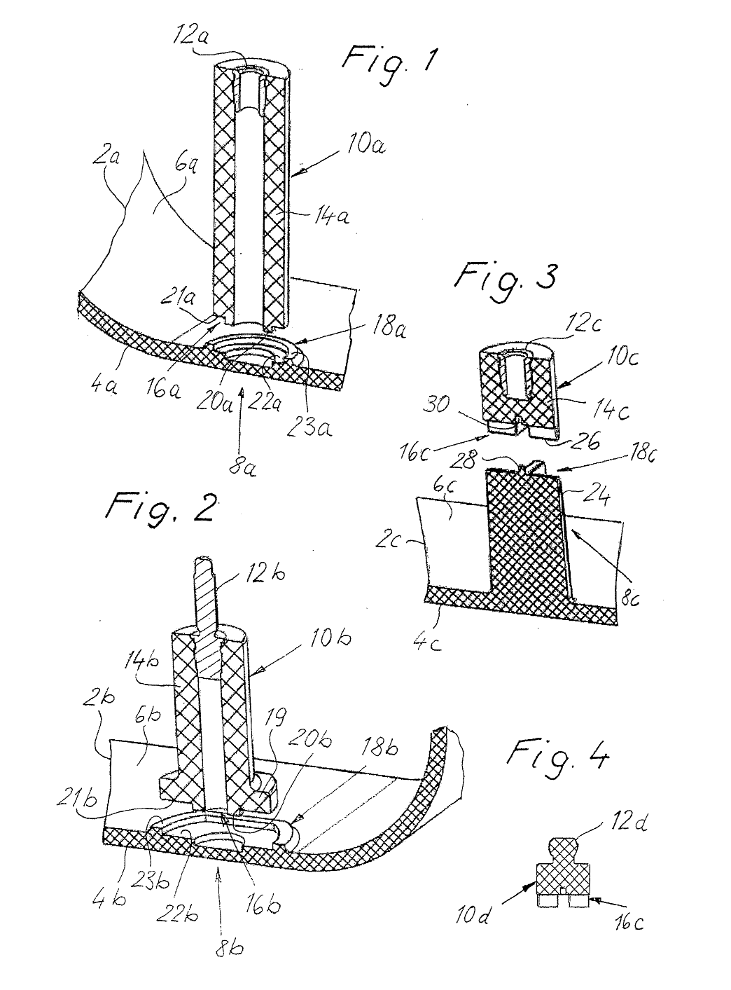

In FIG. 1, a part of a thin-walled component 2a, with a visible side 4a (exterior side) and an inner side 6a, is indicated. A fixing dome 10a, which on its upper end area is provided with a fastening element 12a, is to be mounted on the inner side 6a of the component 2a, in a fastening area 8a.

The thin-walled component 2a is, in particular, a housing, although, other thin-walled components also come into consideration, as was already explained in the preceding.

The term “fixing dome” is to be understood as any arbitrary column-shaped structure that in the mounted state projects from the inner side 6 of the component 2a. In the represented exemplary embodiment, the fixing dome 10a is composed of a sleeve-shaped body 14a with a circular cylindrical outer surface and a circular cylindrical inner surface. It is understood that housings with large volumes or components with large surfaces are provided with a plurality of such fixing domes, which serve to fasten the component 2a on other components, or to connect it to other components. The geometry and the dimensions, especially the height of the fixing dome 10a are selected specific to the application.

The fastening element 12a is, in the exemplary embodiment of FIG. 1, a threaded sleeve, however, it can also be any other fastening or connecting part, as will be explained in connection with the FIGS. 2 to 4.

The fixing dome 10a is provided on its end facing away from the fastening element 12a with a join section 16a, and the component 2a is provided on the inner side 6a in the fastening region 8a with a join section 18a. The join sections 16a and 18a are matched to each other in their geometry, in order to build, in the assembled state, a join connection, through which the fixing dome 10a is fixed in its position relative to the component 2a.

In the exemplary embodiment of FIG. 1, the join sections 16a and 18a are formed as stepped join surfaces 20a, 21a, or 22a, 23a, which rest against each other in the assembled state. The join sections can also be multiply stepped. In the represented exemplary embodiment, the join surfaces 20a to 23a are formed rotationally symmetrically; however, they can also be formed rotationally asymmetrically (FIG. 2).

The fixing dome 10a is formed open on its lower end, in FIG. 1, thus, in the area of the join section; however, it can also be formed closed (FIG. 3). In the exemplary embodiment of FIG. 1, the join sections 16a, 18a have a maximum outer diameter, which is the same or smaller than the outer diameter of the fixing dome 10a. However, here too, a different geometric design is possible, as shown in FIG. 2.

Now, the production of the fastening arrangement of the fixing dome 10a on the component 2a in the fastening area 8a is described. As already explained in the beginning, the component 2a on the one hand and the fixing dome 10a with the fastening element 12a on the other, are produced separately from each other.

The component 2a is produced by injection molding from a synthetic material, especially an impact resistant, abrasion resistant, amorphous thermoplastic. Because the join section 18a in the fastening area 8a requires only a minor material accumulation, no danger exists of sink marks on the visible side 4a of the component 2a. This is in contrast to the initially described state of the art, in which the fixing dome is injection molded together with the thin-walled component.

The fixing dome 10a is also produced by injection molding from a synthetic material, especially an impact resistant, abrasion resistant, amorphous thermoplastic, where during the injection molding procedure, the fastening element 12a is embedded into the material of the fixing dome 10a. The fastening element 12a is usually composed of a metallic material, however, it can also be composed of a different high-strength material, such as, fiber reinforced synthetic material.

The production of component 2a and the fixing dome 10a can be performed very economically due to the relatively simple geometry of these parts, because on the one hand, only short cycle times are necessary, and on the other hand, the injection molding tool can be designed very simply.

When component 2a and the fixing dome 10a have been produced in this way, the join section 16a of the fixing dome 10a and/or the fastening section 18a of the component 2a are provided with a layer of adhesive. Preferably, a light-activated adhesive is used, that is, an adhesive whose curing is initiated by light radiation. Here, there are basically two possible courses of action:

According to one possibility, the fixing dome 10a is produced from a translucent (radiation transparent), especially transparent (see-through) synthetic material, which is transparent for light of a specific wavelength. After wetting the join section with the light activated adhesive, the fixing dome 10a with its join section 16a is inserted into the join section 18a of the component 2, whereby the (mechanical) join connection between these parts is produced. By means of a light source (not shown), light radiation of a predetermined wavelength is now sent through the fixing dome 10a into the area of the join surfaces 20a to 23a, in order to activate the adhesive. If a fast-curing adhesive (instant adhesive) is used, the curing of the adhesive then occurs in a few seconds.

If for any reasons, the fixing dome 10a cannot be produced from a translucent or transparent material, according to the second possibility the method proceeds as follows:

A slow-curing adhesive (minute adhesive) is applied to the join surfaces of the fixing dome 10a and the component 2a, and is activated by light radiation before producing the join connection, whereby the relatively slow-proceeding curing procedure is initiated. Immediately afterwards, the fixing dome 10a and the component 2a are joined on their join sections 16a, 18a. The adhesive cures then—without further outside influence—within, for example, 15 to 30 minutes.

Then, a fastening arrangement of the fixing dome 10a on the component 2a arises that is comparable in its connection strength to that of the state of the art, in which the component and the fixing dome are injection molded together.

The exemplary embodiment of FIG. 2 corresponds largely to that of FIG. 1, wherein corresponding components are designated with the same numbers, however, designated with different letters a and b. Deviating from FIG. 1 are only the type of the fixing element 12b (threaded bolt), the height of the fixing dome 10b and the geometry of the join sections 16b, 18b.

As FIG. 2 shows, the fixing dome 10b in the area of its join section 16b is provided with a circular collar 19, such that the join surfaces 20b to 23b of the join sections 16b, 18b can be formed larger than in FIG. 1. The maximum diameter of the join sections 16b, 18b is thereby significantly greater than the outer diameter of the fixing dome 10b.

In addition, as already mentioned, the join sections 16b, 18b are not formed rotationally symmetrically, but instead, asymmetrically. Therefore, the join connection between the join sections 16b and 18b ensures not only a positioning of the fixing dome 10b transversally to the axis of the fixing dome 10b (parallel to the inner side 6b of the component 2b), but also for a protection against rotation of the fixing dome 10b.

In the exemplary embodiment of FIG. 3, the same reference numbers are used as with the previous exemplary embodiments, and the letters, a, b are replaced by the letter c. Whereas with the exemplary embodiment of the FIGS. 1 and 2, the join section of the fixing dome is formed as projection and the join section of the component as a recess, in the exemplary embodiment of FIG. 3, the join section 18c of the component 2c is formed as a projection, and the join section 16c of the fixing dome 10c as a recess.

Stated more precisely, the join section 18c of the component 2c consists of four crosswise arranged ribs 24, which project perpendicular to the inner side 6c and are molded as one piece onto the wall of the component 2c. The join section 16c of the fixing dome 10c consists of four crosswise arranged grooves 26, whose geometry is matched to that of the ribs 24. It is understood that the number of ribs and grooves can be selected differently.

In the center of the ribs 24, a centering pin 28 is provided that is assigned a corresponding centering hole 30 in the fixing dome 10c. The centering via the centering pin 28 and the centering hole 30, as well as a defined undersize of the width of the ribs 24 with respect to the width of the grooves 26 ensures an optimal and reproducible dimensioning of the gap, receiving the adhesive, between the rib surfaces and the grooves surfaces that are to be connected together.

In contrast to the exemplary embodiments of the FIGS. 1, 2, in the exemplary embodiment of FIG. 3, there is a somewhat larger material accumulation in the fastening area 8c opposite the visible side 4c. However, the material accumulation can be designed clearly smaller than in the state of the art, because the wall thickness and height of the ribs can be selected to be relatively small. In order to prevent sink marks on the visible side 4c with the embodiment of FIG. 3, the wall thickness of the ribs 24 must be less than/equal to ⅔ of the wall thickness of the component 2c.

The production of the fastening arrangement of the fixing dome 10c on the component 2c in FIG. 3 occurs in the same way as was described in connection with the exemplary embodiment of FIGS. 1 and 2.

An important advantage of the exemplary embodiment of FIG. 3 consists in that the fixing dome 10c with the fastening element 12c can be built as a standardized part, whereas a variation of the height of the fastening arrangement is enabled through changes to the height of the ribs 24. As can be seen in FIG. 3, the height of the ribs 24 is larger by a multiple than the depth of the grooves 26. Here, the height of the ribs 24 can be reduced or increased without problem, without any change to the connection between the fixing dome 10c and the component 2c. Therefore, the exemplary embodiment of FIG. 3 is characterized by an especially high cost-effectiveness.

In the exemplary embodiments of the FIGS. 1 to 3, the fastening element 12a, 12b, and 12c, is composed of a different material (especially metal) than that of the fixing dome. Therefore, the fastening element 12a, 12b, and 12c is produced separately from the fixing dome and, during the production of the fixing dome, is embedded into it.

Deviating from this, the possibility exists to produce the fastening element as one piece with the fixing dome. FIG. 4 shows a corresponding example. The fixing dome 10d of FIG. 4 is provided with a fastening element 12d, which serves as a part of a swivel head (ball) for a socket joint (ball socket) of a plug-in coupling, not shown.

As can be seen in FIG. 4, the fastening element 12d is molded as one piece onto the fixing dome 10d. That is, the fixing dome 10d and the fastening element 12d are composed of the same material and are produced together. Otherwise, the fixing dome 10d corresponds to the exemplary embodiment in FIG. 3, i.e., it is formed with the same fastening section 16c.

It is understood that the fastening element molded on the fixing dome as one piece can also be built in another way, for example, as a threaded bolt, a stay bolt, closing link of a quick release fastener, etc.

We claim:

1. A method for producing a fastening arrangement of a column-shaped fixing dome of synthetic material on a thin-walled component of synthetic material, with which method:
the fixing dome and the component are produced separately from each other, wherein the fixing dome is provided with a fastening element and one end of the fixing dome is formed as a join section and wherein further on an inner side of the component, a join section is built, which is matched to the join section of the fixing dome, in order to be able to build a join section with said join section for positioning the fixing dome on the component,
the join section of the component and/or the join section of the fixing dome are wetted with an adhesive, and
subsequently, the component and the fixing dome are joined for producing the join connection, and are fixedly connected together through curing of the adhesive.

2. The method according to claim 1, characterized in that a light curing adhesive is used as an adhesive.

3. The method according to claim 2, characterized in that when the fixing dome is composed of a translucent synthetic material, a fast-curing adhesive is used, and the curing of the adhesive is initiated by means of light radiation of a specific wavelength, after the join connection between the component and the fixing dome has been produced.

4. The method according to claim 2, characterized in that when the fixing dome is composed of a non-translucent synthetic material, a slow-curing adhesive is used, and the curing of the adhesive is initiated, by means of light radiation of a specific wavelength, before the join connection between the component and the fixing dome is produced.

5. The method according to claim 1, characterized in that the fixing dome has a hollow cylindrical shape and on the end formed as the join section is open or closed.

6. The method according to claim 5, characterized in that the fixing dome is formed rotationally symmetrical or rotationally asymmetrical.

7. The method according to claim 1, characterized in that one of the join sections is formed as a recess and the other join section is formed as a projection.

8. The method according to claim 7, characterized in that the join section formed as a recess is provided on the component, and the join section formed as a projection is provided on the fixing dome.

9. The method according to claim 8, characterized in that the join sections are formed stepped.

10. The method according to claim 5, characterized in that the maximum diameter of the join sections is smaller or greater than the maximum diameter of the fixing dome.

11. The method according to claim 7, characterized in that the join section formed as an recess is provided on the fixing dome, and the join section formed as a projection is provided on the component.

12. The method according to claim 11, characterized in that the projection is composed of at least one rib molded onto the component, and the recess is composed of at least one associated groove built into the fixing dome.

13. The method according to claim 12, characterized in that multiple crosswise arranged ribs and grooves are provided.

14. The method according to claim 12, characterized in that the wall thickness of the at least one rib is less than ⅔ of the wall thickness of the component.

15. The method according to claim 12, characterized in that on the at least one rib a centering pin is molded that is inserted into a centering hole of the fixing dome during production of the join connection.

16. The method according to claim 12, characterized in that the height of the at least one rib is greater, by a multiple, than the depth of the at least one groove.

17. The method according to claim 11, characterized in that during use of a plurality of fixing domes, all fixing domes have the same dimensions, and the height of the associated join sections of the component, formed as projections, is matched to different nominal heights of the corresponding fastening arrangements.

18. The method according to claim 1, characterized in that the component is produced from a thermoplastic material by injection molding.

19. The method according to claim 1, characterized in that the fixing dome is produced from a thermoplastic material by injection molding.

20. The method according to claim 1, characterized in that the fastening element is produced from a different material than the fixing dome, and is embedded in the material of the fixing dome.

21. The method according to claim 1, characterized in that the fastening element is composed of the same material as the fixing dome, and is formed together with it as one piece.
